(19) United States
(12) Patent Application Publication
(10) Pub. No.: US 2025/0364864 A1
(43) Pub. Date: Nov. 27, 2025

(54) BEARING CURRENT MITIGATION

(71) Applicant: Rivian IP Holdings, LLC, Irvine, CA (US)

(72) Inventors: Yanyan Xie, Rancho Palos Verdes, CA (US); Khwaja Rahman, Troy, MI (US); Silva Hiti, Redondo Beach, CA (US); Yo Chan Son, Rancho Palos Verdes, CA (US); Logan Noel Balliett, Los Angeles, CA (US); Lon C. Cooper, Redondo Beach, CA (US)

(73) Assignee: Rivian IP Holdings, LLC, Irvine, CA (US)

(21) Appl. No.: 18/673,885

(22) Filed: May 24, 2024

(51) Int. Cl. H02K 5/22; H02K 1/12

(52) U.S. Cl. CPC H02K 5/225; H02K 1/12

(57) ABSTRACT

An apparatus can include a stator, a housing, and an electrical connector. The electrical connector can establish an electrical connection between the stator and the housing. The electrical connector can create a path to discharge current from a bearing via the electrical connection.

### INTRODUCTION

Vehicles can include drive unit assemblies that include one or more components thereof.

### SUMMARY

This disclosure is generally related to one or more components of a vehicle. The components can include an apparatus. The apparatus can include an electrical connector. The electrical connector can establish an electrical connection between a stator and a housing. The electrical connector can provide electrical bonding between the stator and the housing. For example, the electrical bonding can include welding a plurality of laminations of the stator to one another. The electrical bonding can reduce bearing currents by providing a path to discharge current.

At least one aspect is directed to an apparatus. The apparatus can include a stator, a housing, and an electrical connector. The electrical connector can establish an electrical connection between the stator and the housing. The electrical connector can create a path to discharge current from a bearing via the electrical connection.

At least one aspect is directed to a vehicle. The vehicle can include a drive unit assembly. The drive unit assembly can include a stator, a housing, and a bearing. The vehicle can include an electrical connector. The electrical connector can establish an electrical connection between the stator and the housing. The electrical connector can create a path to discharge current from the bearing via the electrical connection.

At least one aspect is directed to a method. The method can include disposing an electrical connector at least partially between a stator and a housing. The method can include establishing, by the electrical connector, an electrical connection between the stator and the housing. The method can include creating, by the electrical connector responsive to establishing the electrical connection, a path to discharge current from a bearing via the electrical connection.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example electric vehicle.

FIG. 2 depicts an example perspective view of a stator including an electrical connector.

FIG. 3 depicts an example perspective view of a drive unit assembly including a stator disposed within a housing.

FIG. 4 depicts an example perspective view of an electrical connector disposed between the stator and the housing illustrated in FIG. 3.

FIG. 5 depicts an example perspective view of an electrical connector disposed within an aperture of the stator illustrated in FIG. 3.

FIG. 6 depicts an example cross-sectional view of electrical connector disposed between the stator and the housing illustrated in FIG. 5.

FIG. 7 depicts an example perspective view of laminations of the stator illustrated in FIG. 3.

FIG. 8 depicts an example perspective view of a lamination of the laminations illustrated in FIG. 7.

FIG. 9 depicts an example perspective view of the laminations illustrated in FIG. 7.

FIG. 10 depicts an example perspective view of electrical connectors disposed between laminations of the stator illustrated in FIG. 3.

FIG. 11 depicts an example perspective view of the electrical connectors illustrated in FIG. 10 disposed between the stator and the housing illustrated in FIG. 3.

FIG. 12 depicts an example perspective view of the electrical connectors illustrated in FIG. 10 disposed between the stator and the housing illustrated in FIG. 3.

FIG. 13 depicts an example perspective view of electrical connectors disposed within an aperture of the stator illustrated in FIG. 3.

FIG. 14 depicts an example perspective view of the electrical connectors illustrated in FIG. 13 coupled with a fastener.

FIG. 15 depicts an example perspective view of an electrical connector.

FIG. 16 depicts an example perspective view of the electrical connector illustrated in FIG. 15 disposed between the stator and the housing illustrated in FIG. 3.

FIG. 17 depicts an example perspective view of the electrical connector illustrated in FIG. 15 disposed between the stator and the housing illustrated in FIG. 3.

FIG. 18 depicts an example perspective view on an electrical connector disposed between the stator and the housing illustrated in FIG. 3.

FIG. 19 depicts an example perspective view of an electrical connector coupled with the housing illustrated in FIG. 3.

FIG. 20 depicts an example perspective view of the electrical connector illustrated in FIG. 19 coupled with the housing illustrated in FIG. 3.

FIG. 21 depicts an example cross-sectional view of the electrical connector disposed between the stator and the housing illustrated in FIG. 20.

FIG. 22 depicts an example perspective view of an electrical connector disposed between the stator and the housing illustrated in FIG. 3

FIG. 23 depicts an example perspective view of the electrical connector illustrated in FIG. 22 coupled with a first side of the stator illustrated in FIG. 22.

FIG. 24 depicts an example perspective view of the electrical connector illustrated in FIG. 22 disposed between the stator and the housing illustrated in FIG. 22.

FIG. 25 depicts an example flow diagram of a process of manufacturing an apparatus.

### DETAILED DESCRIPTION

Following below are more detailed descriptions of various concepts related to, and implementations of, methods, apparatuses, and systems of an electrical connector. The various concepts introduced above and discussed in greater detail below may be implemented in any of numerous ways.

The present disclosure is directed to systems and methods of one or more components for a vehicle. The components can include an electrical connector. The electrical connector can be coupled with one or more components of a drive unit assembly. For example, the electrical connector can be welded to at least one lamination or lamination sheet of the stator. To continue this example, the welding of the electrical connector the laminations can establish an electrical connection between the stator and a housing. The electrical connection or electrical bonding can create a path to discharge current from a bearing. The discharging of current from the bearing can reduce bearing currents.

Bearing current can stress bearings in electric machines. For example, the presence of bearing in an inverter-driven machine can stress the bearings. In inverter-driven electric machines (e.g., drive unit assemblies, etc.), windings of a stator can be excited with pulse width modulation (PWM) voltages that include multiple pulses. The PWM voltages can generate discharging current that can flow through a complex circuit of a drive unit. The discharging current can flow in a path that includes windings, the stator, the rotor, and the house. The path can include engaging the bearings between the housing the rotor. The discharging current along the path can stress the bearings as the PWM voltages are discharged by the bearings in the form of bearing currents.

Some systems can include and/or install conductive brushes on a housing to create low resistance between a rotor shaft and the housing. The low resistance can be parallel to the bearing, thereby the discharging current can flow to the low resistance. However, the conductive brushes are prone to frequent maintenance or replacing. Chokes can also be added to windings of the stator to filter the PWM voltage. However, the chokes are also prone to frequent maintenance or replacing.

The disclosed solutions have a technical advantage of providing an electrical connector that can be disposed between a stator and a housing. The electrical connector can remove or eliminate bearing currents by creating a path to discharge current from the PWM voltages via an electrical connection between the stator and the housing. The electrical connector can establish the electrical connection by establishing electrical binding between laminations of the stator and a housing. The electrical binding can reduce the voltage potential of the stator and create a path for the voltage to discharge without producing bearing currents. The electrical connector, all or in part, can be an integral part of the stator, for example stator components or materials can form at least part pf the electrical connector.

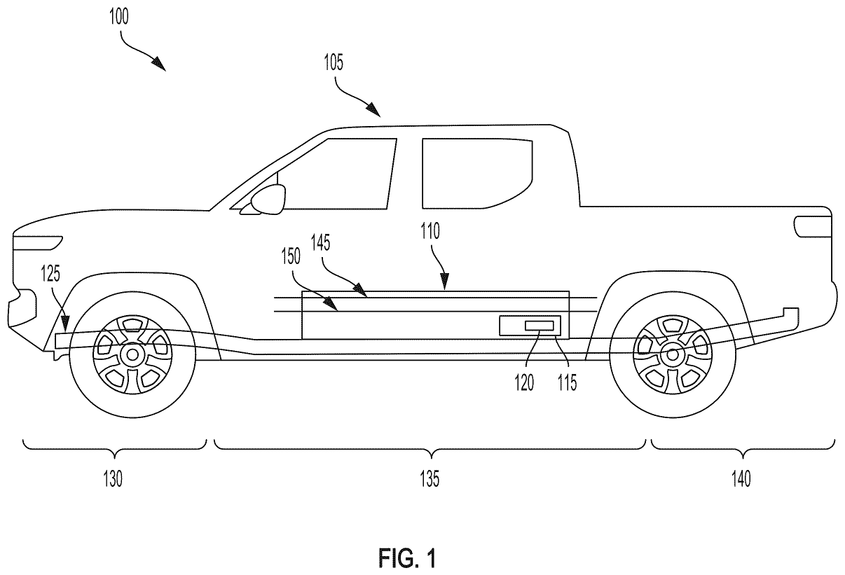

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery modules 115, or the battery cells 120 with other electrical components of the electric vehicle 105 to provide electrical power to various systems or components of the electric vehicle 105.

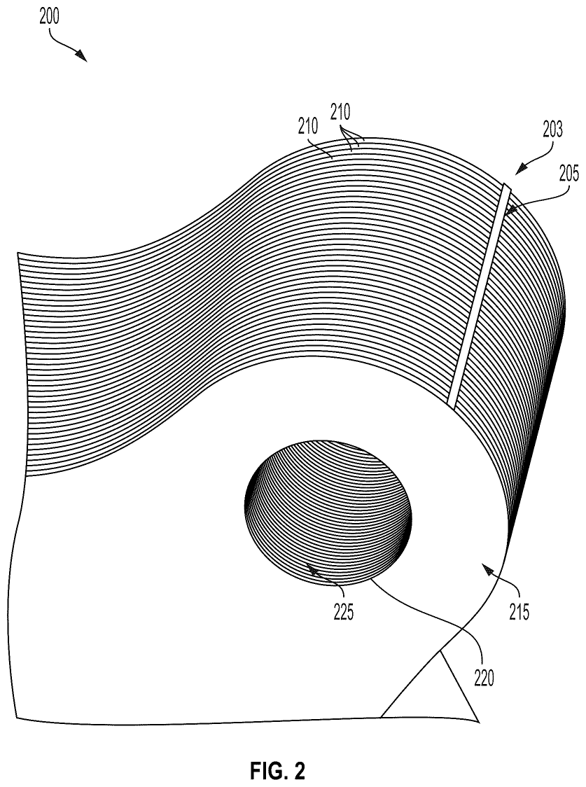

FIG. 2 depicts a perspective view of a stator 200. That stator 200 can be included in a drive unit assembly. For example, the stator 200 can electrically couple with an inverter. The stator can include at least protrusion 215. For example, the protrusions 215 can include a stator car. As another example, the protrusions 215 can extend beyond a body of the stator 200. The stator 200 can include at least one lamination 210. For example, the stator 200 can include multiple laminations 210 arranged as sheets. The protrusion 215 can include at least aperture 220. The aperture 220 can include at least one of an opening, a void, a cavity, or a tunnel. The aperture 220 can extend along the laminations 210. For example, the aperture 220 can originate at a first lamination 210 and the aperture 220 can terminate at a second lamination 210. The aperture 220 can include at least surface 225.

The stator 200 can be integrated with an apparatus 203. For example, the apparatus 203 can be coupled with the stator 200. As another example, the apparatus 203 can include the stator 200. The apparatus 203 can include at least one electrical connector 205. The electrical connectors 205 can refer to and/or include the electrical connectors described herein. The electrical connector 205 can be integrated with or include at least part of the stator 200. For example, the electrical connector 205 can be coupled with the laminations 210. As another example, the electrical connector 205 can be formed by welding at least two laminations 210 to one another. As another example, the electrical connector 205 can be formed by heating the laminations 210 to cause at least a portion of insulation coatings of the laminations 210 to melt and add solder to a surface of the laminations to bond the laminations 210 to one another. Stated otherwise, the electrical connector 205 can bond or connect the laminations 210 to one another to form at least part of a conductive pathway.

The electrical connector 205 can include a connection between the laminations 210. For example, as shown in FIG. 2, the electrical connector 205 can originate at the first lamination 210 and the electrical connector 205 can terminate at the second lamination 210. To continue this example, the electrical connector 205 can establish a connection between the first lamination 210 and the second lamination 210. The electrical connector 205 can coupled with the laminations 210 at a position of the stator 200 with a magnetic flux below a predetermined threshold. The electrical connector 205 can couple at the position of the stator with low magnetic flux to reduce or prevent an increase of iron loss while welding the electrical connector 205 with the stator 200 or the laminations 210.

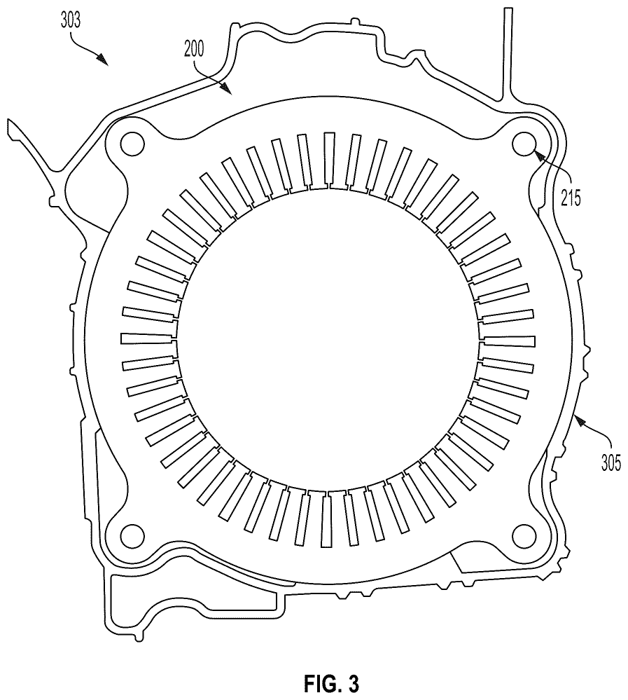

FIG. 3 depicts a perspective view of a drive unit assembly 303. The drive unit assembly 303 can include the stator 200 and a housing 305. The stator 200 can be disposed withing the housing 305. For example, the stator 200 can be placed, positioned, located, or otherwise situated within the housing 305.

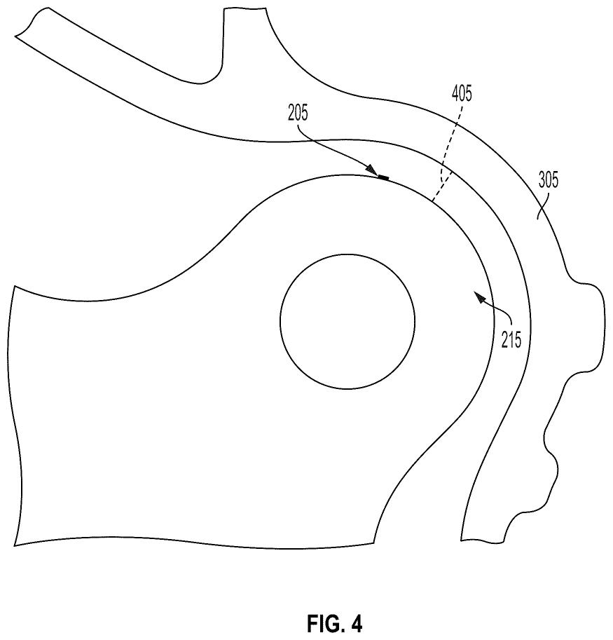

FIG. 4 depicts a perspective view of the electrical connector 205 disposed between the stator 200 and the housing 305. The electrical connector 205 can establish an electrical connection between the stator 200 and the housing 305. For example, the electrical connector 205 can establish an electrical bond between the stator 200 and the housing 305. The electrical bond (e.g., the electrical connection) can reduce or eliminate bearing currents that flow to a bearing of the drive unit assembly 303. The electrical connector 205 can create a path to discharge current.

For example, the electrical connector 205 can provide a path for current to flow and bypass the bearing current of the drive unit assembly by establishing the electrical connection between the stator 200 and the housing 305.

The electrical connector 205 can be disposed at least partially between the stator 200 and the housing 305. For example, at least a portion of the electrical connector 205 can be located or positioned in a gap or void between the stator 200 and the housing 305. As another example, the electrical connector 205 can be disposed at least partially between the protrusion 215 and the housing 305. As shown in FIG. 4, at least a portion of the electrical connector 205 can be positioned in a cavity 405. The cavity 405 can define a space or an area between the protrusion 215 and the housing 305. The laminations 210 at the end of the stator 200 can be electrically connected to the housing 305 while the stator 200 is being assembled into the housing 305.

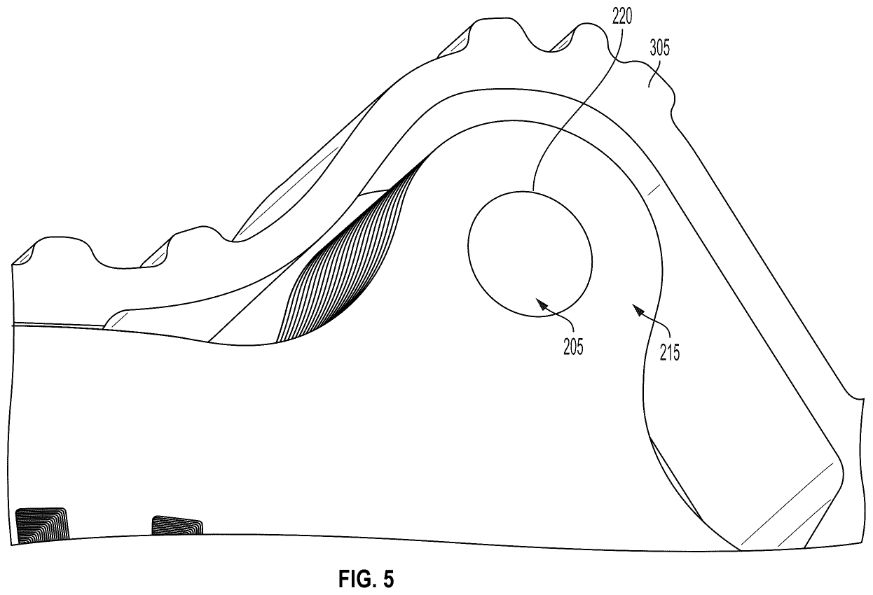

FIG. 5 depicts a perspective view of the electrical connector 205 disposed within the aperture 220. The electrical connector 205 can surround at least a portion of the aperture 220. For example, the electrical connector 205 can surround at least a portion of the surface 225. The electrical connector 205 can extend along the surface 225. For example, the electrical connector 205 can extend from a first face of the aperture 220 to a second face of the aperture 220. The electrical connector 205 can extend less than a length of the aperture 220. For example, the aperture 220 can extend along twenty laminations 210, or along any subset or combinations of laminations 210 that are included in the stator 200.

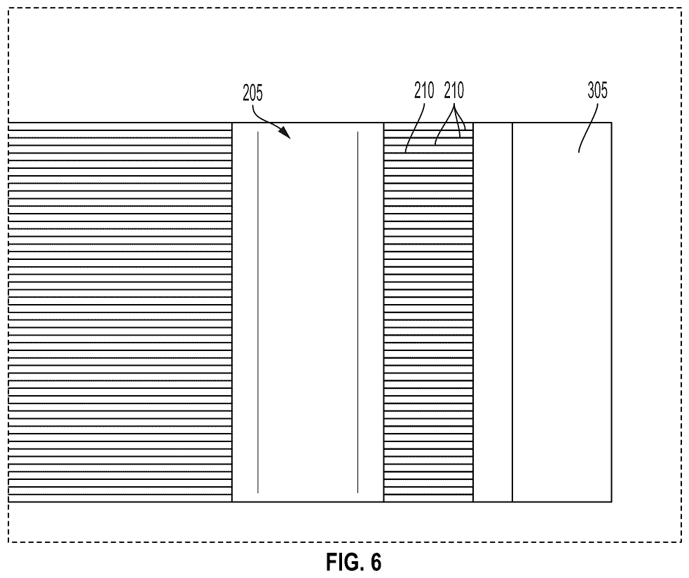

FIG. 6 depicts a cross-section view of the electrical connector 205, the laminations 210, and the housing 305. The electrical connector 205 can include a bushing or electrically conductive material. For example, the electrical connector 205 can include copper material. As another example, the electrical connector 205 can include aluminum. The electrical connector 205 can provide electrical bonding between the laminations 210 and the housing 305. For example, the electrical connector 205 can bond the laminations 210 with the housing 305 to create a path to discharge current from the stator to the housing 305.

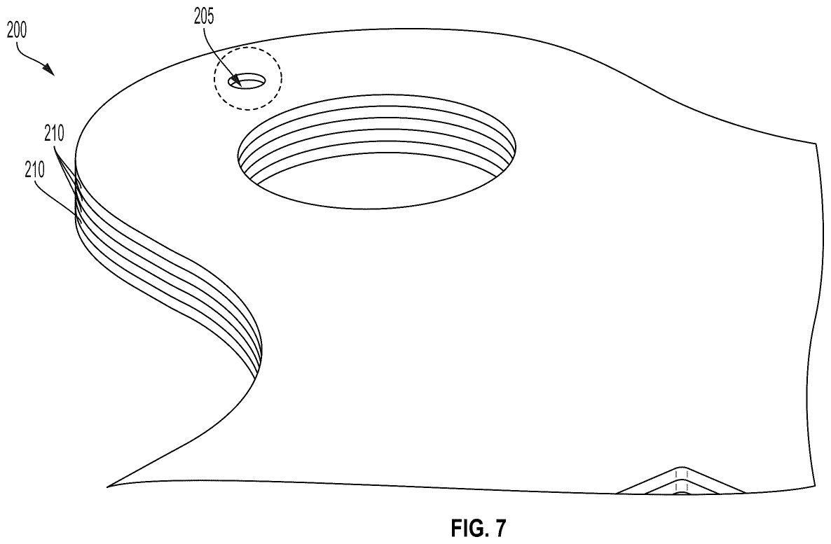

FIG. 7 depicts a perspective view of the laminations 210 arranged as lamination sheets. The laminations 210 can be stacked and/or situated on top of one another. For example, a first lamination 210 can interlock with or sit on top of a second lamination 210. As another example, a first lamination 210 can be placed or stacked on top of a second lamination 210 to couple the first lamination 210 with the second lamination 210. The laminations 210 can be integrated with the electrical connector 205. For example, the laminations 210 can include the electrical connectors 205. As another example, the electrical connector 205 can be coupled with the laminations 210. The electrical connector 205 can include a connection between one or more laminations 210. For example, the electrical connector 205 can include a connection between a first lamination 210 and a second lamination 210.

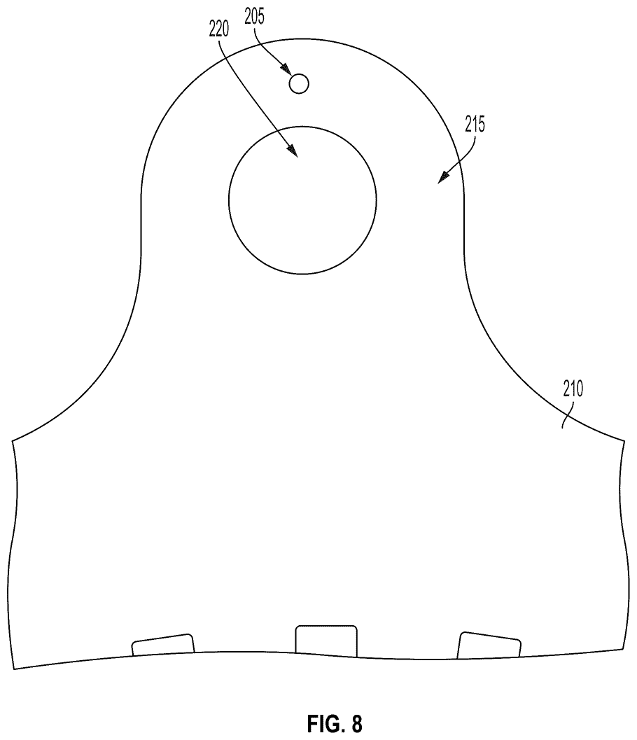

FIG. 8 depicts a perspective view of a single lamination 210. The electrical connector 205 can be established during a manufacturing process of the laminations 210. For example, an indent can be added to a mold that is used while manufacturing the laminations 210. To continue this example, the indent can establish the electrical connector 205. As another example, the indent can be added, after manufacturing the laminations 210, by applying a force or pressure on the laminations 210. As shown in FIG. 8, the electrical connector 205 can be located or positioned superior to the aperture 220. For example, the electrical connector 205 can be located in a portion of the protrusion 215 that is located above (e.g., superior) the aperture 220.

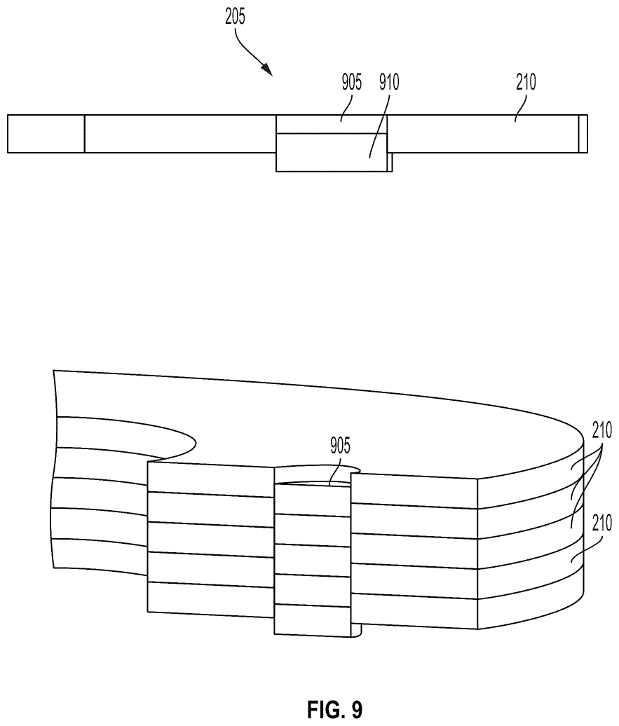

FIG. 9 depicts a perspective view of the laminations 210. The electrical connectors 205 can include at least one recess 905 and at least one protrusion 910. As shown in FIG. 9, a first protrusion 910 of a first lamination 210 can be inserted in or rest within a second recess 905 of a second lamination 210. The insertion of the protrusions 910 into the recesses 905 can define or establish an interlock feature of the laminations 210. The interlock feature of the laminations 210, via the electrical connector 205, can provide electrical connections between the laminations 210.

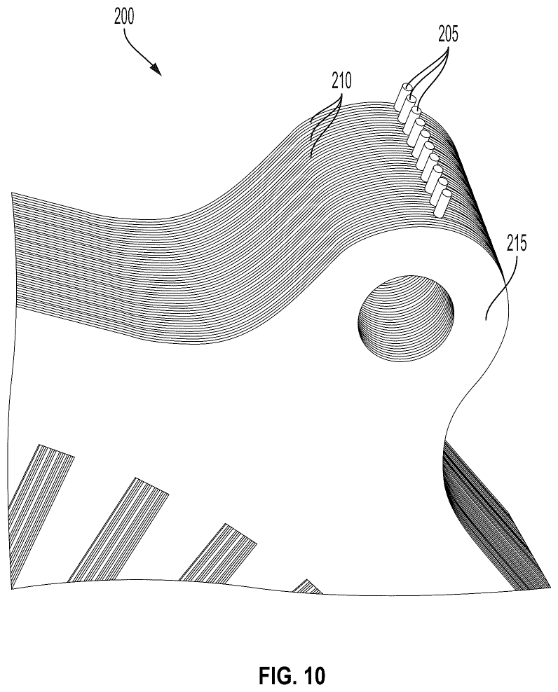

FIG. 10 depicts a perspective view of the electrical connectors 205 disposed between one or more laminations 210. The apparatus 203 can also include multiple electrical connectors 205. For example, the apparatus 203 can include a first electrical connector 205 and a second electrical connector 205. The electrical connectors 205 can be disposed between the laminations 210. For example, the first electrical connector 205 can be located between at least two laminations 210 (e.g., a first lamination 210 and a second lamination 210).

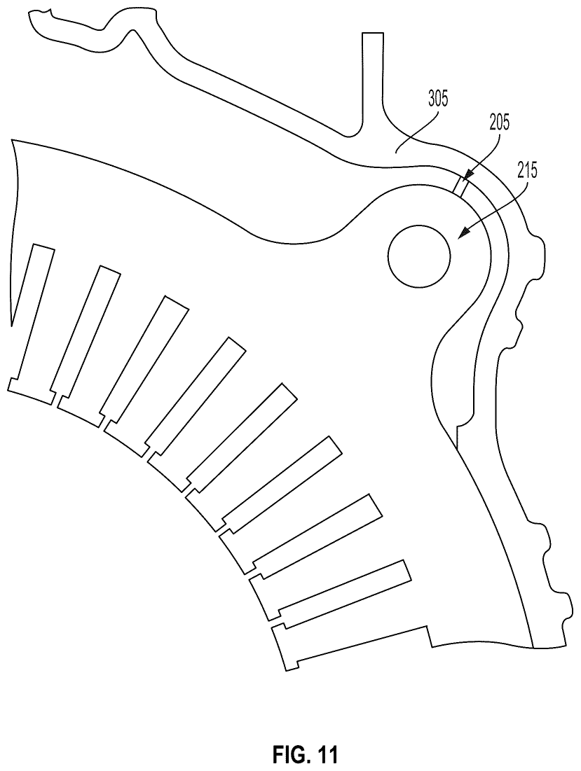

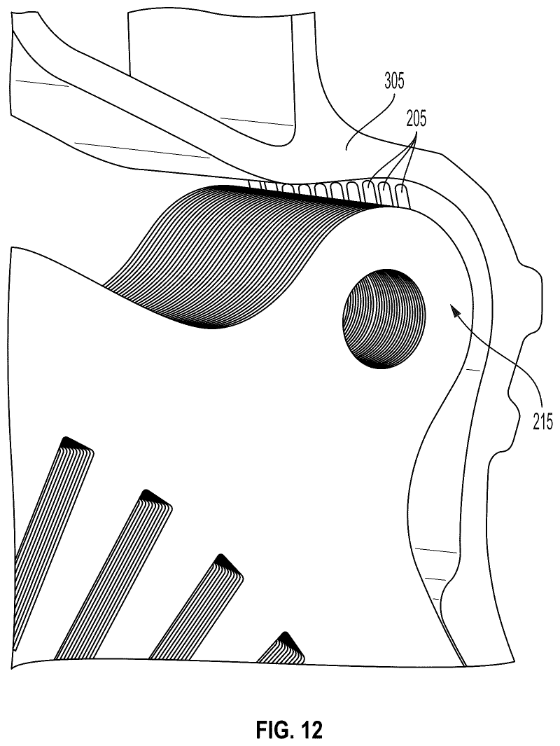

FIGS. 11-12 depict perspective views of the electrical connectors 205 disposed between the stator 200 and the housing 305. The electrical connectors 205 can couple with the laminations 210. For example, the electrical connectors 205 can be attached, mounted, secured, adjoined, and/or otherwise connected to the laminations 210. The electrical connectors 205 can be modular or fabricated laminations 210. For example, while stamping the laminations 210 a die can be used that makes or adds a piece of steel to form or define the electrical connectors 205 within or along the laminations 210 across the stator 200. The laminations 210 and the electrical connectors 205 can form a unitary or integrated body that are electrically coupled with one another. The electrical connector 205 can be disposed at least partially between the protrusions 215 and the housing 305. For example, the electrical connectors 205 can be located within the cavity 405.

The electrical connectors 205 can include at least one tab per lamination 210. For example, the stator 200 can include ten laminations 210. To continue this example, the electrical connectors 205 can include ten tabs (e.g., a 1:1 ratio between a number of laminations 210 and a number of tabs). As another example, the number of tabs in relation to the number of laminations 210 can vary. For example, there can be a 1:2 ratio, a 1:4 ratio, or other possible rations between the number of laminations 210 and the number of tabs. The electrical connectors 205 can press or contact the housing 305. For example, the electrical connectors 205 can contact the housing 305 responsive to insertion of the stator 200 within the housing 305 as shown in FIG. 12. As another example, the tabs of the electrical connectors 205 can exert a force of the housing 305.

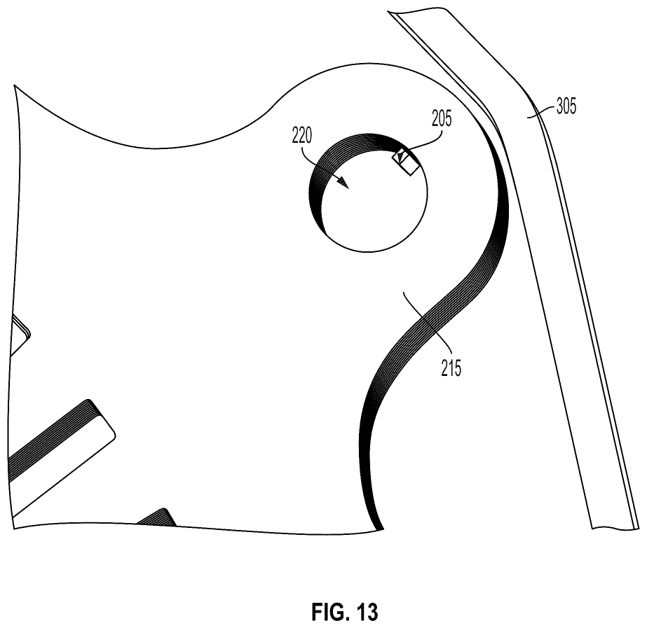

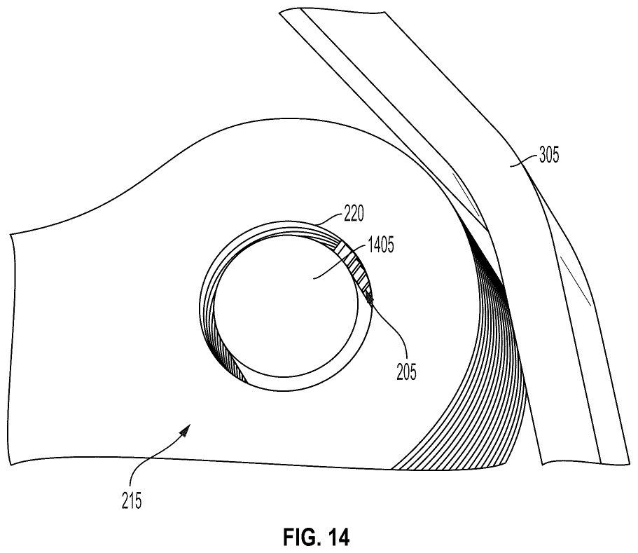

FIGS. 13-14 depict perspectives view of the electrical connectors 205 disposed within the aperture 220. For example, the electrical connector 205 can be placed, positioned, or otherwise located within the aperture 220. The electrical connectors 205 can provide an electrical bonding between the laminations 210. For example, as shown in FIG. 14, the electrical connector 205 can contact a fastener 1405. The fastener 1405 can couple the stator 200 with the housing 305. The fastener 1405 can include a conductive bolt. The electrical connector 205 can press against the fastener 1405. The fastener 1405 can couple or attach the stator 200 with the housing 305. The fastener 1405 can fix or secure the stator 200 in at least one given position or location.

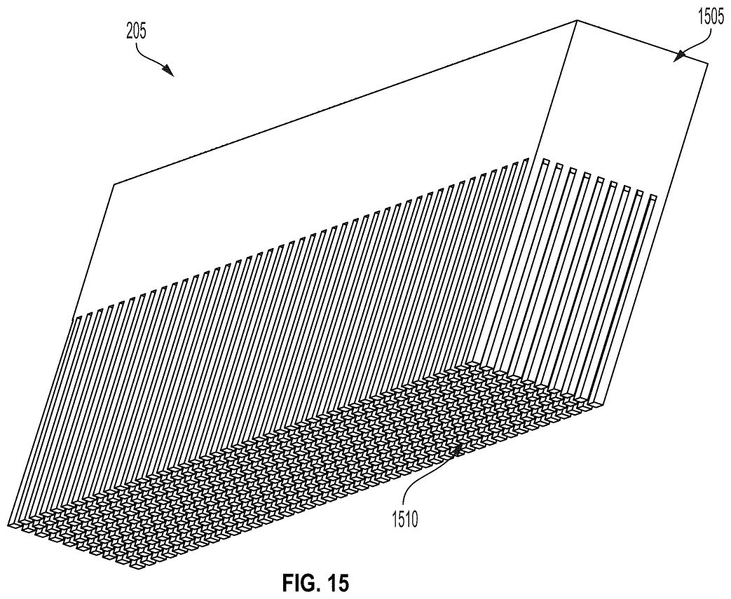

FIG. 15 depicts a perspective view of the electrical connector 205. The electrical connector 205 can include brushes. For example, the electrical connector 205 can include electrically conductive brushes. The electrical connector 205 can include grounding devices, such as bushes, spring clips, cast ribs, or other possible devices. The electrical connector 205 can include at least one or more portions. For example, as shown in FIG. 15, the electrical connector 205 can include a first portion 1505 and a second portion 1510. The portions (e.g., the first portion 1505 and the second portion 1510) can refer to or include at least one of a top, a bottom, a side, a face, a surface, or other part of the electrical connector 205. For example, the first portion 1505 can represent a top of the electrical connector 205. As another example, the second portion 1510 can represent a bottom of the electrical connector 205. The electrical connector 205 can include at least one shape. For example, as shown in FIG. 15, the electrical connector 205 can include a rectangular shape. As another example, the electrical connector 205 can include a triangular prism shape.

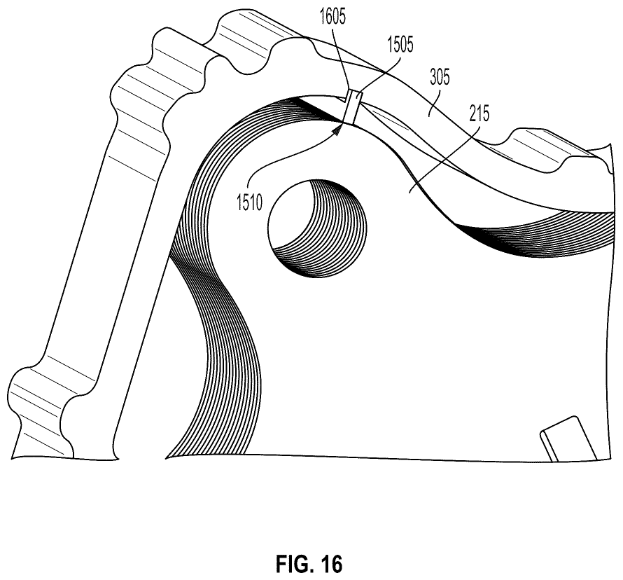

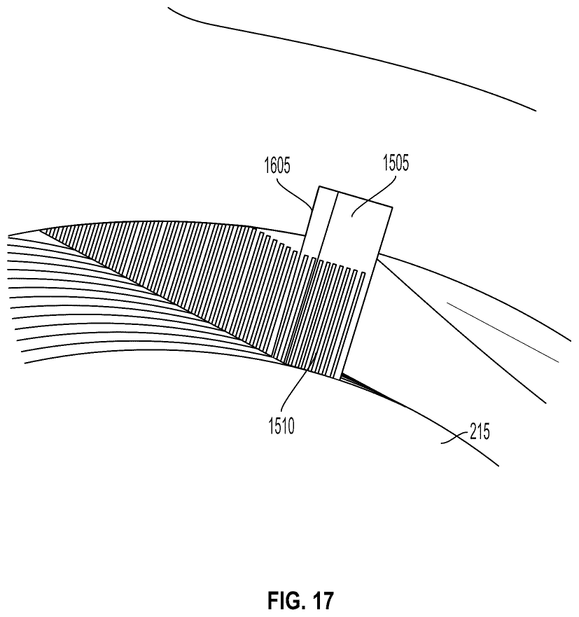

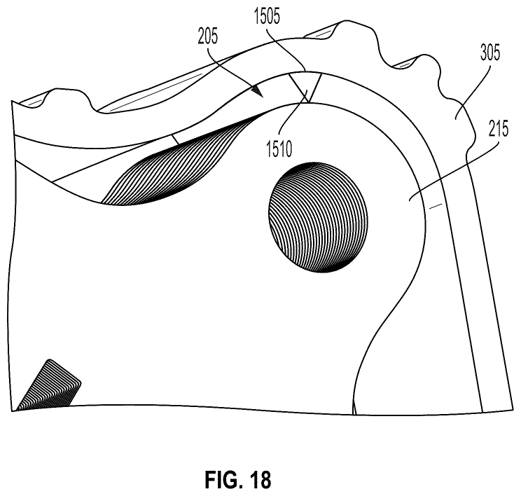

FIGS. 16-18 depict perspective view of the electrical connector 205 disposed between the stator 200 and the housing 305. The housing 305 can include at least one portion 1605. For example, the portion 1605 can include a recess or an indent. As another example, the portion 1605 can include a slot. The electrical connector 205 can be disposed at least partially within the housing 305. For example, the first portion 1505 can be disposed or placed at least partially within the portion 1605. As another example, the first portion 1505 can be coupled with or integrated with the portion 1605. The electrical connector 205 can couple with the stator 200. For example, the second portion 1510 can be mounted, secured, attached, or otherwise adjoined with the protrusion 215. As another example, the second portion 1510 can be welded to the laminations 210. The electrical connector 205 can contact the stator 200. For example, the second portion 1510 or one or more brushes thereof can contact the laminations 210. The electrical connector 205 can establish an electrical connection between the housing 305 with the first portion 1505 coupled with the housing 305 and with the second portion 1510 in contact with the laminations 210.

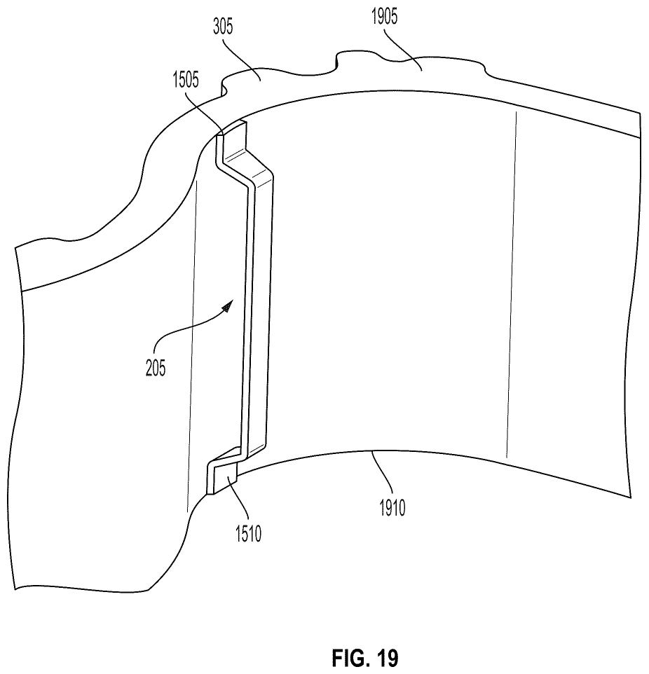

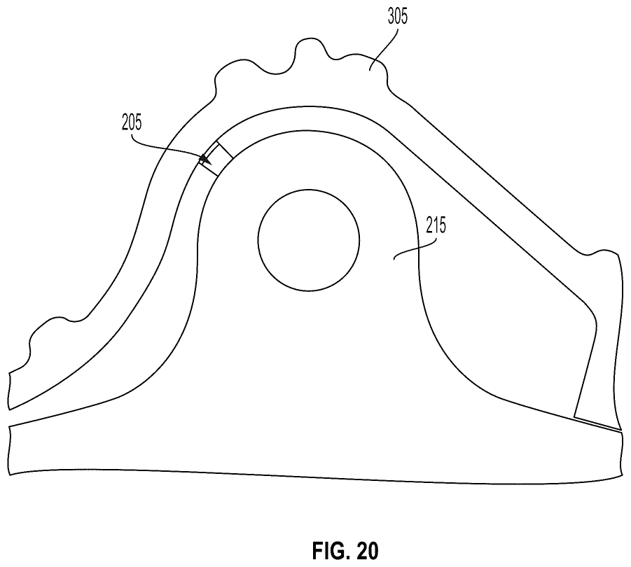

FIGS. 19-20 depict perspectives view of the electrical connector 205 coupled with the housing 305. For example, as shown in FIG. 19, the first portion 1505 can couple with a first side 1905 of the housing 305. As another example, the second portion 1510 can couple with a second side 1910 of the housing 305. As shown in FIG. 20, the electrical connector 205 can be disposed or located within the cavity 405. FIGS. 19 and 20 depict examples of the electrical connector 205 as a spring clip. The electrical connector 205 can contact the laminations 210 with the stator 200 disposed within the housing 305.

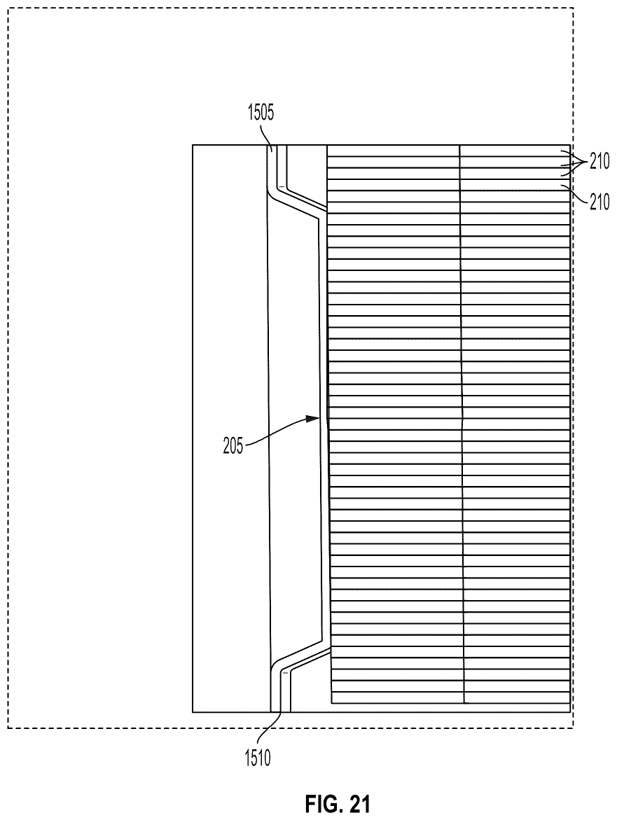

FIG. 21 depicts a cross-sectional view of the electrical connector 205 disposed between the stator 200 and the housing 305. As shown in FIG. 21, the electrical connector 205 can contact the laminations 210. For example, the laminations 210 can be pressed against the electrical connector 205 responsive to the stator 200 having been disposed within the housing 305. As another example, the stator 200 can be disposed within the housing 305 while pressing or otherwise compressing the electrical connector 205.

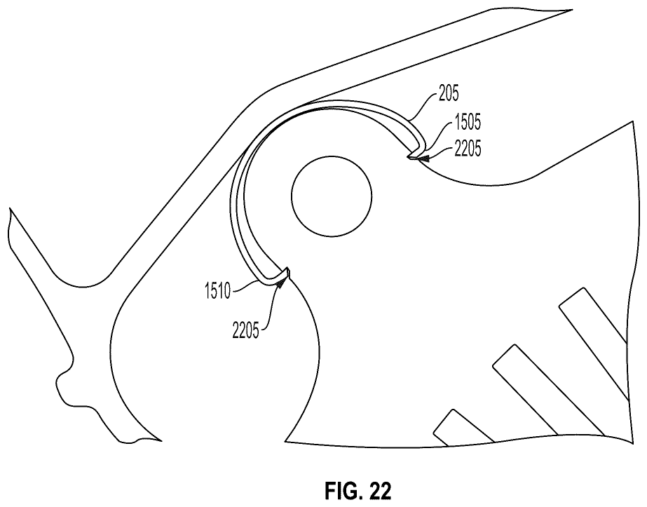

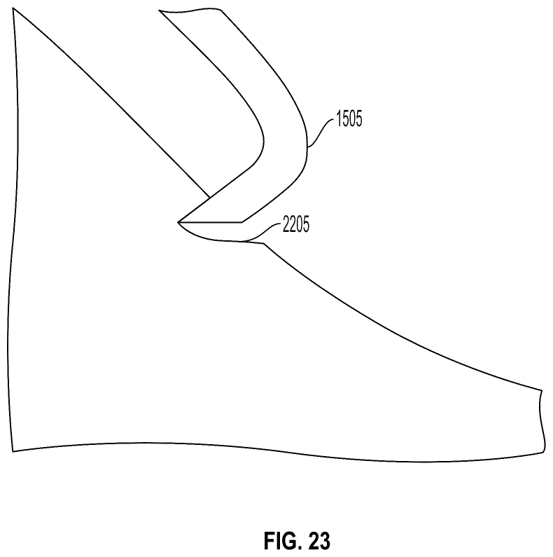

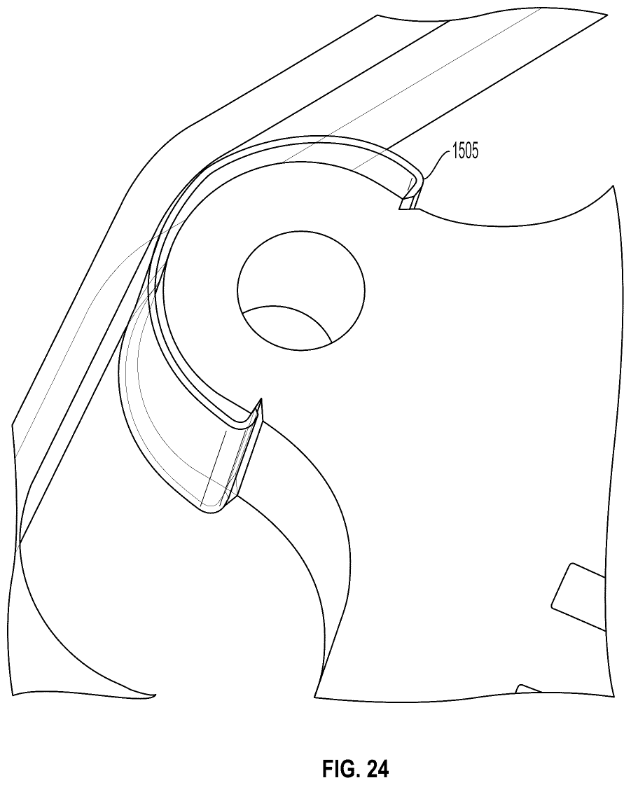

FIGS. 22-24 depict perspective views of the electrical connector 205 coupled with the stator 200. As shown in FIG. 22, the first portion 1505 can be disposed within a first recess 2205 of the protrusion 215. The second portion 1510 can be disposed within a second recess 2205. The electrical connector 205 can be coupled with the protrusion 215 with the first portion 1505 disposed in the first recess 2205 and with the second portion 1510 disposed in the second recess 2205. The first portion 1505 or the second portion 1510 can contact at least one side of the protrusion 215. For example, the first recess 2205 can refer to or include a first side of the protrusion 215. As another example, the second recess 2205 can refer to or include a second side of the protrusion 215.

FIGS. 22-24 depict examples of the electrical connector 205 as a metal clip. The electrical connector 205 can establish an electrical connection between the laminations 210 with the electrical connector 205 (e.g., the first portion 1505 and the second portion 1510) in contact with the protrusion 215 via the first recess 2205 and the second recess 2205. The electrical connector 205 can contact the housing 305.

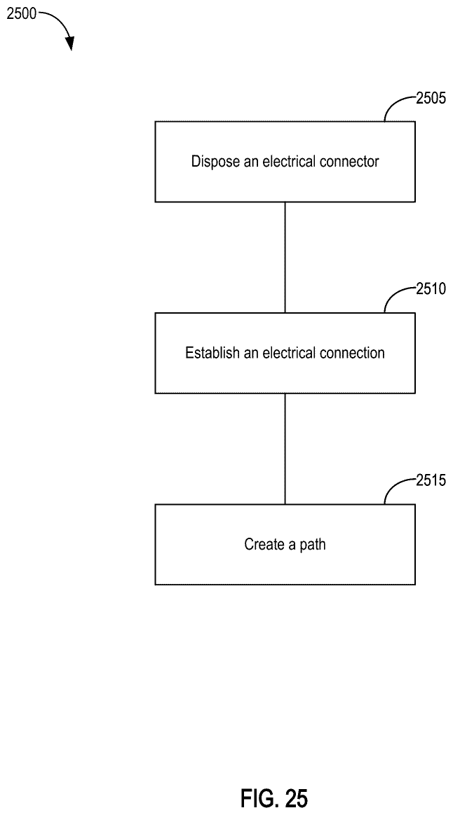

FIG. 25 depicts a flow diagram of a process 2500 for manufacturing an apparatus. The apparatus can include the apparatus 203. The apparatus 203 can include the electrical connector 205. The manufacturing of the apparatus 203 can include providing the apparatus 203. For example, the apparatus 203 can be provided during assembly of the vehicle 105. The apparatus 203 can be provided responsive to the apparatus 203 having been purchased.

At step 2505, an electrical connector can be disposed. For example, the electrical connector 205 can be disposed between the stator 200 and the housing 305. The electrical connector 205 can be disposed by at least one of placing, positioning, locating, or otherwise situating the electrical connector 205 between the stator 200 and the housing 305. For example, the electrical connector 205 can located within the cavity 405.

At step 2510, an electrical connection can be established. For example, the electrical connector 205 can establish an electrical connection between the stator 200 and the housing 305. The electrical connector 205 can establish the electrical connection with the electrical connector 205 in contact with or coupled with the stator 200 or the housing 305. For example, the electrical connector 205 can be welded to the laminations 210. To continue this example, the electrical connector 205 can establish an electrical connection between the stator 200 and the housing 305 responsive to the stator being disposed within the housing 305.

At step 2515, a path can be created. For example, a path can be created between the stator 200 and the housing 305. The path can be created by the electrical connection established in step 2510. For example, the electrical connection between the stator 200 and the housing 305 can create a path for current to discharge. The discharge of current, via the electrical connection, can reduce or eliminate bearing currents. For example, the discharge of current, via the electrical connection, can reduce current that is discharged by one or more bearings of the drive unit assembly 303.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer based components.

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a stator;
a housing; and
an electrical connector configured to:
establish an electrical connection between the stator and the housing; and
create a path to discharge current from a bearing via the electrical connection.

2. The apparatus of claim 1, comprising:
the electrical connector disposed at least partially between the stator and the housing.

3. The apparatus of claim 1, comprising:
the stator including a plurality of laminations; and
the electrical connector including a connection between at least two laminations of the plurality of laminations.

4. The apparatus of claim 1, comprising:
the stator including a protrusion;
the electrical connector configured to surround at least a portion of a surface of an aperture of the protrusion.

5. The apparatus of claim 1, comprising:
the electrical connector comprising a plurality of electrical connectors; and
the plurality of electrical connectors configured to dispose between at least two laminations of a plurality of laminations of the stator.

6. The apparatus of claim 1, comprising:
the stator including:
a plurality of laminations; and
a protrusion; and
the electrical connector configured to:
couple with the plurality of laminations; and
dispose at least partially between the protrusion and the housing.

7. The apparatus of claim 1, comprising:
the stator including a protrusion;
the protrusion including an aperture; and
the electrical connector configured to dispose within the aperture.

8. The apparatus of claim 1, comprising:
the electrical connector including:
a first portion configured to dispose at least partially within the housing; and
a second portion to couple with the stator.

9. The apparatus of claim 1, comprising:
the electrical connector, including:
a first portion configured to couple with the housing; and
a second portion configured to contact at least a portion of a protrusion of the stator.

10. The apparatus of claim 1, comprising:
the electrical connector, including:
a first portion configured to couple with a first side of the housing; and
a second portion configured to couple with a second side of the housing.

11. The apparatus of claim 1, comprising:
the electrical connector, including:
a first portion configured to contact a first side of a protrusion of the stator; and
a second portion configured to contact a second side of the protrusion.

12. A vehicle, comprising:
a drive unit assembly, including:
a stator;
a housing; and
a bearing; and
an electrical connector configured to:
establish an electrical connection between the stator and the housing; and
create a path to discharge current from the bearing via the electrical connection.

13. The vehicle of claim 12, comprising:
the electrical connector disposed at least partially between the stator and the housing.

14. The vehicle of claim 12, comprising:
the stator including a plurality of laminations; and
the electrical connector including a connection between at least two laminations of the plurality of laminations.

15. The vehicle of claim 12, comprising:
the stator including a protrusion; and
the electrical connector configured to surround at least a portion of a surface of an aperture of the protrusion.

16. The vehicle of claim 12, comprising:
the electrical connector comprising a plurality of electrical connectors; and
the plurality of electrical connectors configured to dispose between at least two laminations of a plurality of laminations of the stator.

17. The vehicle of claim 12, comprising:
the electrical connector, including:
a first portion configured to dispose at least partially within the housing; and
a second portion to couple with the stator.

18. A method, comprising:
disposing an electrical connector at least partially between a stator and a housing;
establishing, by the electrical connector, an electrical connection between the stator and the housing; and
creating, by the electrical connector responsive to establishing the electrical connection, a path to discharge current from a bearing via the electrical connection.

19. The method of claim 18, the electrical connector comprising a plurality of electrical connectors, and comprising:
disposing the plurality of electrical connectors between at least two laminations of a plurality of laminations of the stator.

20. The method of claim 18, the stator including a plurality of laminations and a protrusion, and comprising:
coupling the electrical connector with the plurality of laminations; and
disposing the electrical connector at least partially between the protrusion and the housing.
